(19) United States
(12) Patent Application Publication
(10) Pub. No.: US 2018/0052893 A1
(43) Pub. Date: Feb. 22, 2018

(54) DATABASE MANAGEMENT USING A MATRIX-ASSISTED LASER DESORPTION/IONIZATION TIME-OF-FLIGHT MASS SPECTROMETER

(71) Applicants: Eung Joon Jo, Old Tappan, NJ (US); Yohahn Jo, Old Tappan, NJ (US)

(72) Inventors: Eung Joon Jo, Old Tappan, NJ (US); Yohahn Jo, Old Tappan, NJ (US)

(21) Appl. No.: 15/682,251

(22) Filed: Aug. 21, 2017

Related U.S. Application Data
(60) Provisional application No. 62/377,768, filed on Aug. 22, 2016.

(51) Int. Cl. G06F 17/30; H01J 49/00; H01J 49/04; H01J 49/40; G06F 17/18

(52) U.S. Cl. CPC G06F 17/30536; H01J 49/0036; G06F 17/18; G06F 17/30047; H01J 49/40; H01J 49/0418

(57) ABSTRACT

An apparatus, method, or computer program. Spectrometer test data of a sample may be received. The received test data may be matched to a reference library to determine characteristic information of the sample by correlating the test data to at least one of a plurality of reference data in the reference library. The updating the reference library with the test data as new reference data based is on the correlating. The matching may be performed in a cloud computing system.

The present application claims priority to U.S. Provisional Patent Application No. 62/377,768 filed on Aug. 22, 2016, which is hereby incorporated by reference in its entirety.

### BACKGROUND

A biomarker is a biological molecule found in blood, other body fluids, or tissues that is a sign of a normal or abnormal process, or of a condition or disease. For example, a glycoprotein CA-125 is a biomarker that signals the existence of a cancer. Hence, biomarkers are often measured and evaluated to identify the presence or progress of a particular disease or to see how well the body responds to a treatment for a disease or condition. Existence or a change in quantity level of biomarkers in proteins, peptides, lipids, glycan or metabolites can be measured by mass spectrometers.

Among numerous types of mass spectrometers, Matrix-Assisted Laser Desorption/Ionization Time-of-Flight Mass Spectrometry (MALDI-TOF MS) is an analytical tool employing a soft ionization technique. Samples are embedded in a matrix and a laser pulse is fired at the mixture. The matrix absorbs the laser energy and the molecules of the mixture are ionized. The ionized molecules are then accelerated through a part of a vacuum tube by an electrical field and then fly in the rest of the chamber without fields. Time-of-flight is measured to produce the mass-to-charge ratio (m/z). MALDI-TOF MS offers rapid identification of biomolecules such as peptides, proteins and large organic molecules with very high accuracy and subpicomole sensitivity. MALDI-TOF MS may be used in a laboratory environment to rapidly and accurately analyze biomolecules and expanding its application to clinical areas such as microorganism detection and disease diagnosis such as cancers.

Disease diagnosis using MALDI-TOF MS in a clinical environment, however, presents several problems. One problem is poor reproducibility of the mass analysis data. In particular, sample preparation process is a major factor affecting data reproducibility of MALDI-TOF MS, where a specific target material is extracted from an original sample, mixed with a matrix and then loaded onto a sample plate. Handling processes may inevitable involve human intervention where a person manually moves samples from one processing step to another processing step and/or performs a number of experimental processes. This makes the data susceptible to uncontrolled external influences, which leads to poor homogeneity or separability of a sample and a risk of sample contamination.

Another factor affecting data reproducibility is the measurement sensitivity or measuring process of the MALDI-TOF MS system itself. While MALDI-TOF MS can analyze samples fast with high sensitivity so that it would be an excellent tool for clinical application, it may be a relatively poor quantitative analyzer because Relative Standard Deviation (RSD) of detected signal intensities is relatively high due to its nature of ionization process using organic matrix. Even though the MALDI-TOF MS system adopts a delayed extraction technique, it may be challenging to have all the particles of a mass get the same kinetic energy just before entering a field-free zone in the chamber. It may be an inevitable data spread source.

In addition to the low reproducibility issue, disease diagnosis using MALDI-TOF in a clinical environment may present cost issues, maintenance issues, and/or difficulties in sample preparation. Some systems may be too expensive and bulky to be used in a clinical environment and/or too difficult to use for point-of-care testing (“POCT”) and/or onsite care. To be used in a clinical and/or POCT/Onsite care environment, an entire system may need to be compact, easy to manage, capable of generating more reproducible data, and/or having a relatively low cost.

Another challenge may be in a diagnostic process with library database in which a matching operation of test data from a test sample may need to be compared to a relatively large database. For practical reasons (e.g. size of database, propriety of database, processing power required to search database, data update, diagnostics software upgrade, etc.), there are complications in providing a relatively large and updated database internal to a spectrometer. Such complications may have performance effects on the operation of a diagnosis system.

### SUMMARY

Embodiments relate to an apparatus, method, or computer program. Spectrometer test data of a sample may be received. The received test data may be matched to a reference library to determine characteristic information of the sample by correlating the test data to at least one of a plurality of reference data in the reference library. The updating the reference library with the test data as new reference database is automatically confirmed and carefully finalized based upon its pre-defined constraints on the correlation accuracy with the artificial intelligence-based software algorithm. In embodiments, the matching is performed in a cloud computing system.

### DRAWINGS

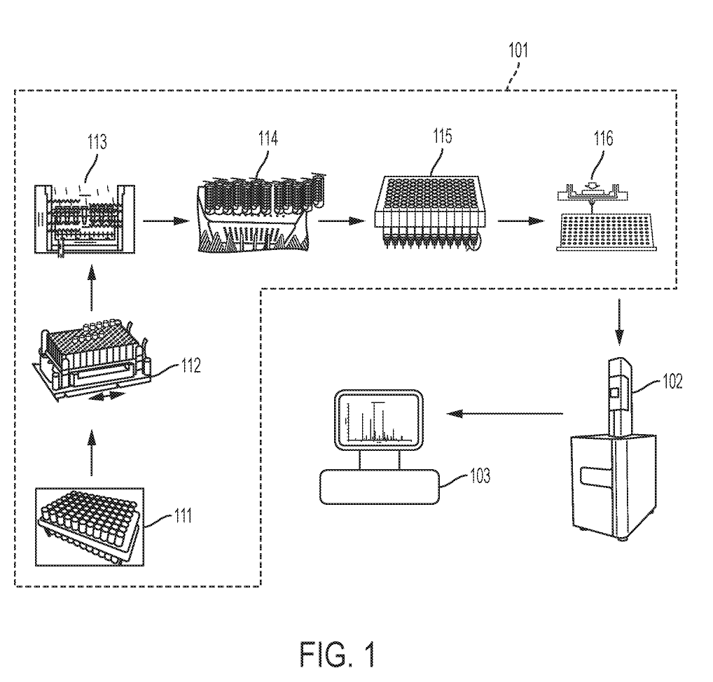

Example FIG. 1 is an arrangement of a disease diagnosis laboratory where a sample processing unit, a MALDI-TOF MS unit, and a diagnosis unit are separated in three different systems, in accordance with embodiments.

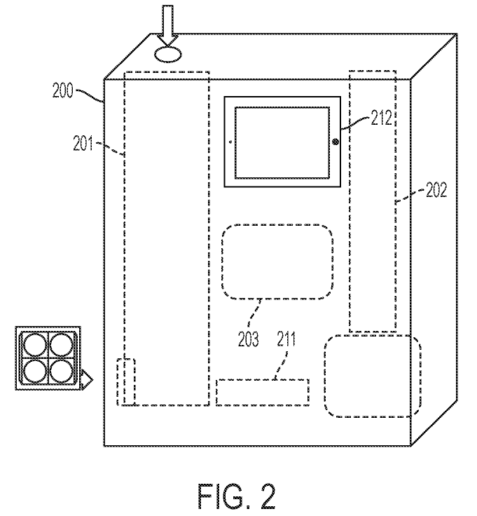

Example FIG. 2 is a system diagram including a sample processing unit, a MALDI-TOF MS unit, and a diagnosis unit integrated into one system, in accordance with embodiments.

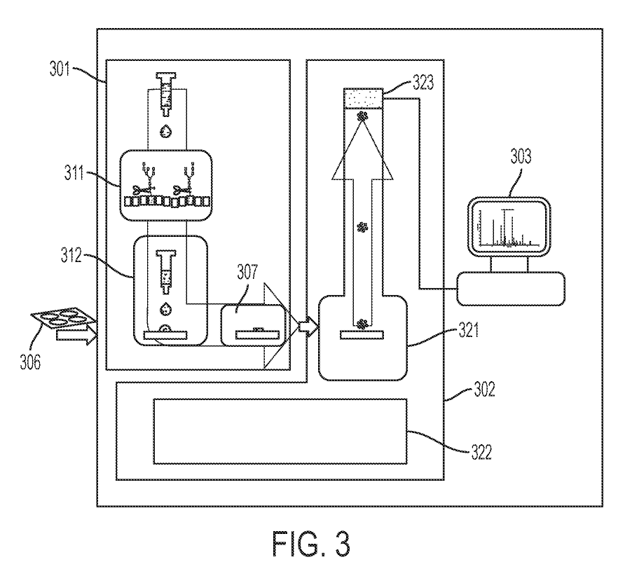

Example FIG. 3 is a system diagram of the integrated system including a sample processing unit, a MALDI-TOF MS unit, and a diagnosis unit in one system, in accordance with embodiments.

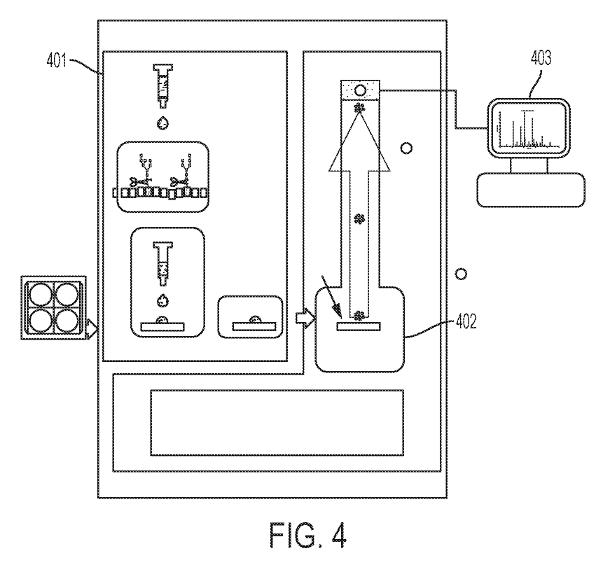

Example FIG. 4 is a system diagram of an integrated diagnostic system including a sample processing unit and a MALDI-TOF MS unit integrated in one system, whereas a diagnosis unit is provided as a separate unit, in accordance with embodiments.

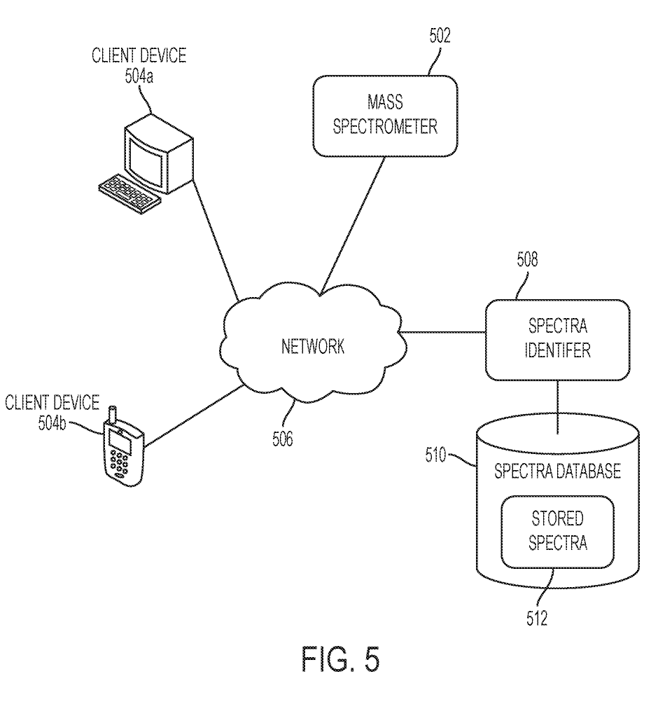

Example FIG. 5 shows spectra identifier 108 configured to communicate, via network 106, with mass spectrometer 102 and client devices 104a, 104b, in accordance with embodiments.

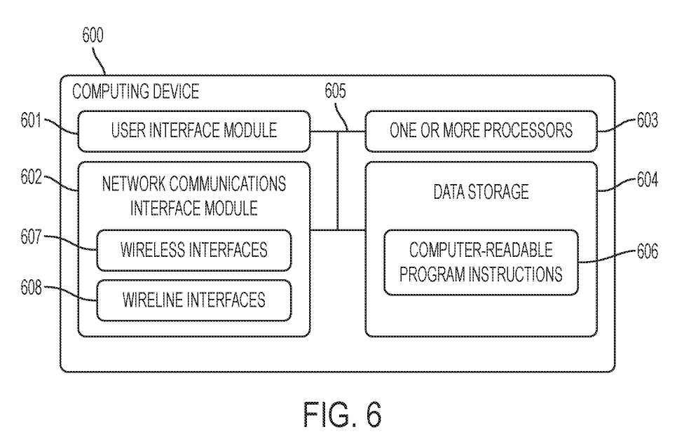

Example FIG. 6 a block diagram of a computing device (e.g., system) in accordance with an example embodiment. FIG. 2B depicts a network 106 of computing clusters 209a, 209b, and 209c arranged as a cloud-based server system, in accordance with embodiments.

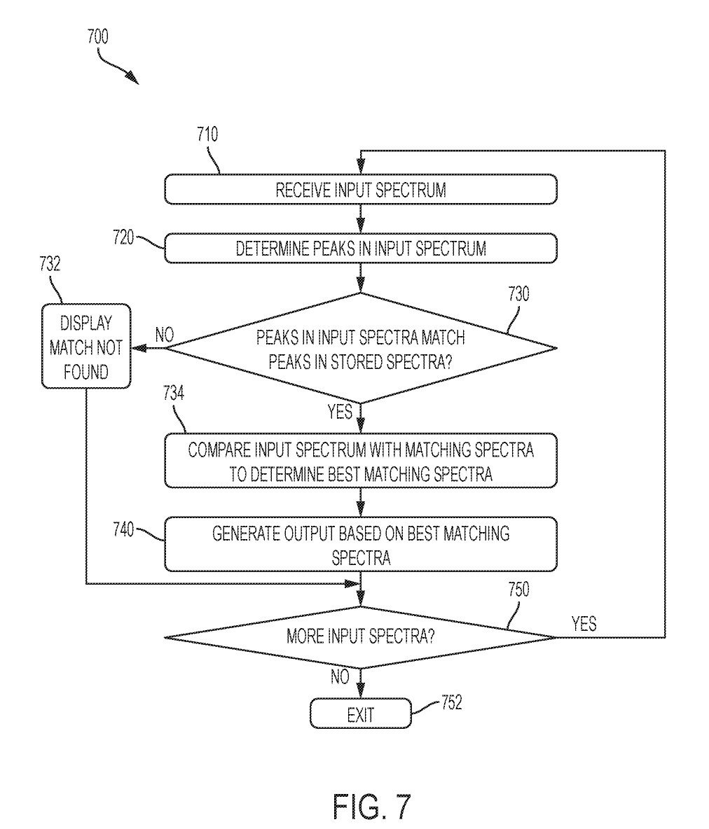

Example FIG. 7 shows an example method 300 for spectral identification, in accordance with embodiments.

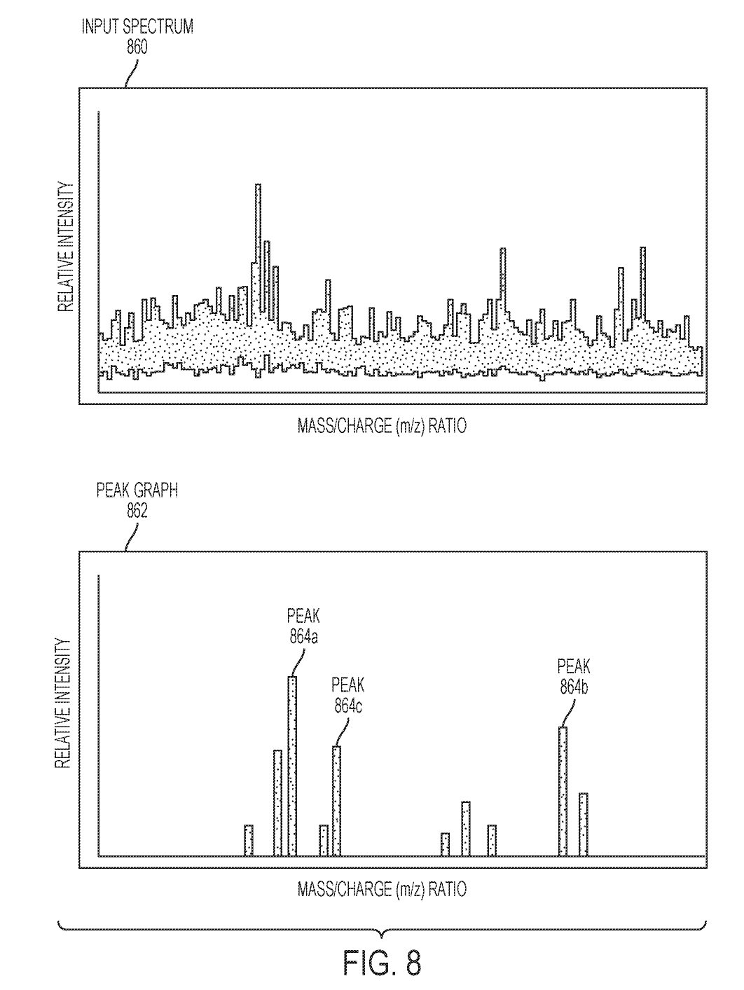

Example FIG. 8 shows and example input spectrum 360 and corresponding graph 362 of peaks of input spectrum 360, in accordance with embodiments.

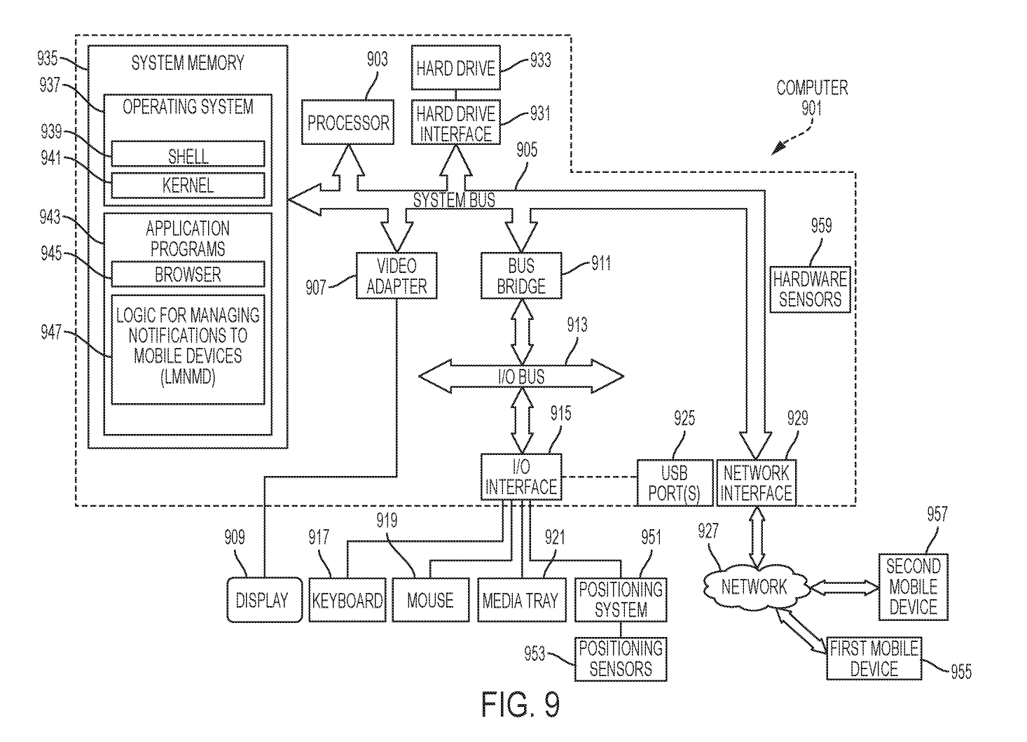

Example FIG. 9 a block diagram of an exemplary system and network, in accordance with embodiments.

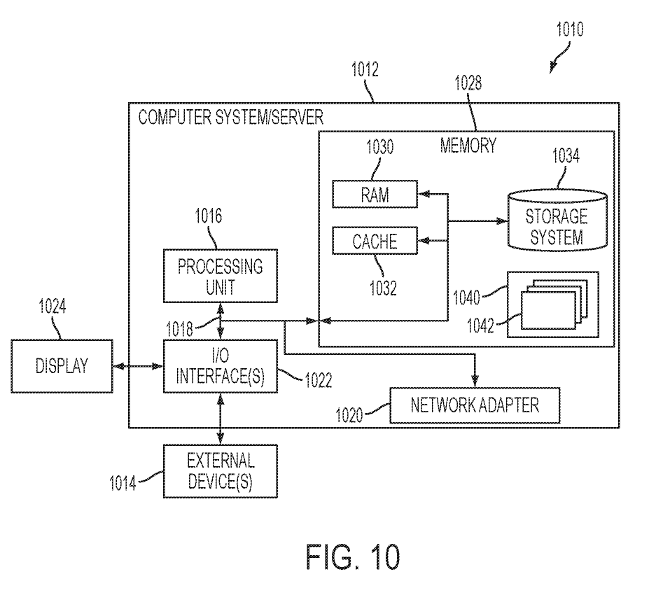

Example FIG. 10 depicts a cloud computing node, in accordance with embodiments.

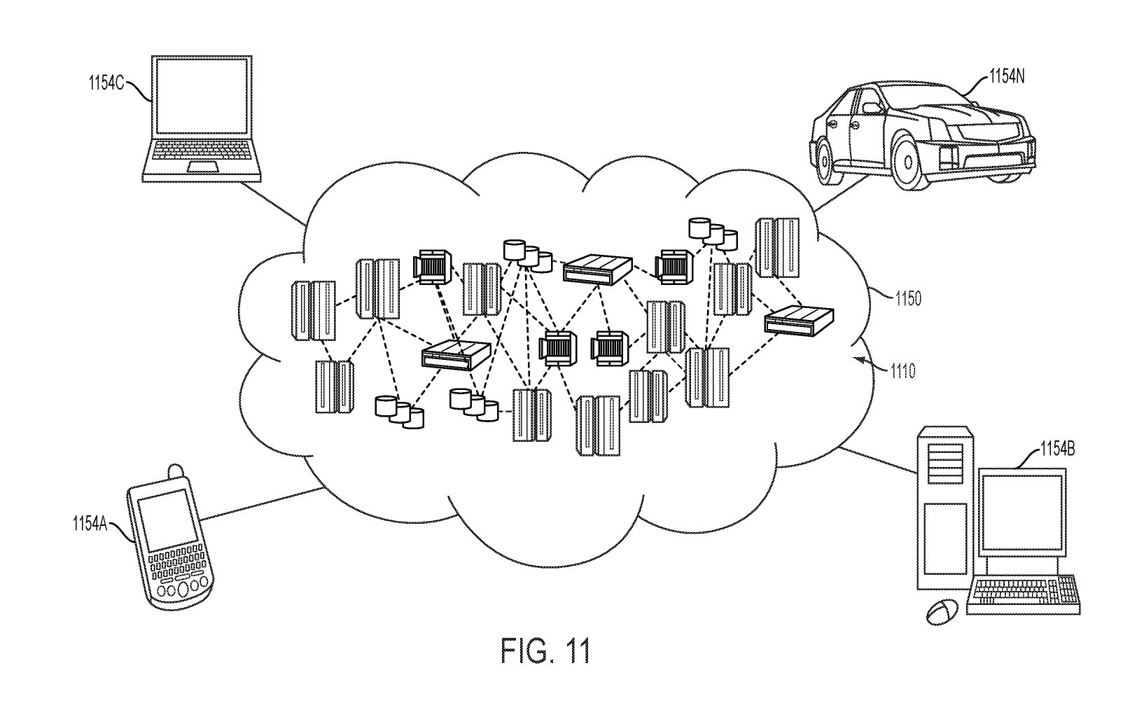

Example FIG. 11 depicts a cloud computing environment, in accordance with embodiments.

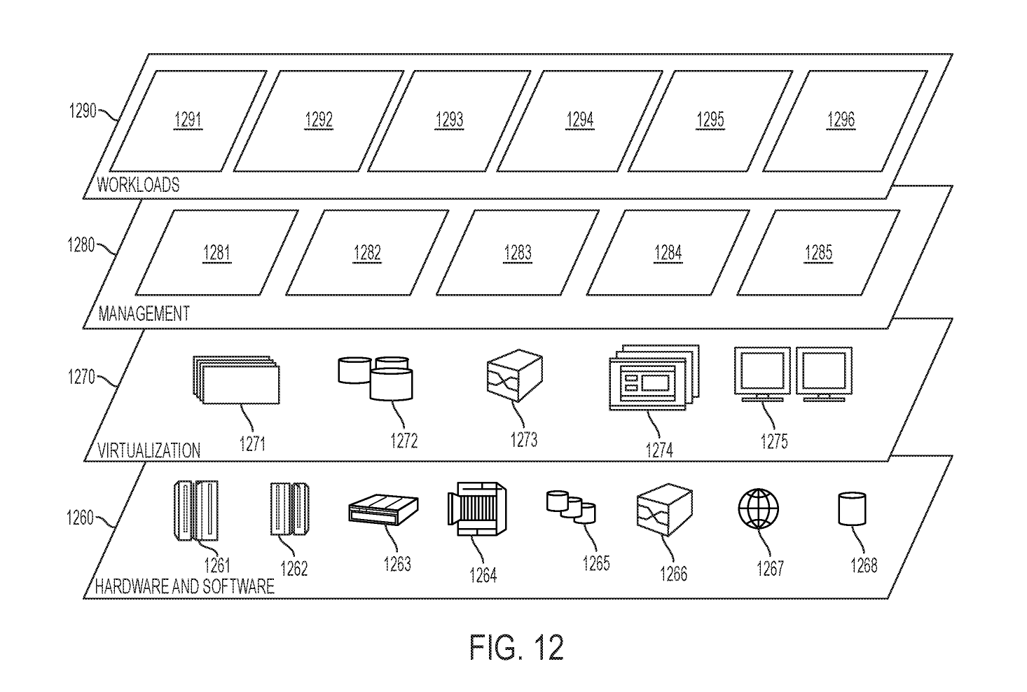

Example FIG. 12 depicts abstraction model layers, in accordance with embodiments.

### DESCRIPTION

A biomarker is a biological molecule found in blood, other body fluids, or tissues that is a sign of a normal or abnormal process, or of a condition or disease. Among numerous types of mass spectrometers, Matrix-Assisted Laser Desorption/Ionization Time-of-Flight Mass Spectrometry (MALDI-TOF MS) is an analytical tool employing a soft ionization technique. MALDI-TOF MS may be used in a laboratory environment to rapidly and accurately analyze biomolecules and expanding its application to clinical areas such as microorganism detection and disease diagnosis such as cancers.

A factor affecting data reproducibility may be the measurement sensitivity or measuring process and protocols of a MALDI-TOF MS system. While MALDI-TOF MS may be able to analyze samples fast with high sensitivity, there may be quantitative analysis complications because Relative Standard Deviation (RSD) of detected distribution profiles may be relatively high due to imperfections in the ionization process. In embodiments, the spectrometer data may be calibrated, standardized, normalized, and/or otherwise manipulated in manners that make the data more reproducible.

Example FIG. 1 illustrates a disease diagnosis laboratory where a sample processing facility 101 includes multiple sample processing tools, a MALDI-TOF MS system 102, and a diagnosis software system 103, which are separated from each other, in accordance with embodiments. To extract a glycan for an ovarian cancer diagnosis, for example, a patient's serum is entered into a multi-well plate 111 to undergo a sample reception process and a protein denaturation process 112, followed by a deglycosylation process using enzyme 113. A protein removal process 114, a drying and centrifugation process, a glycan extraction process 115, and a spotting process 116 then follow. The spotted samples are analyzed by the MALDI-TOF MS system 102 to generate at least one glycan profile. The diagnosis software 103 compares the glycan profile of the sample with the pre-stored glycan profile or profiles to identify the presence and progress of ovarian cancer. Example FIG. 2 is a schematic view of a MALDI-TOF MS system, in accordance with embodiments.

Example FIG. 3 is a system diagram of the integrated system including a sample processing unit, a MALDI-TOF MS unit, and a diagnosis unit in one system, in accordance with embodiments. Samples may undergo a combination of process by selected modules in the sample processing unit. In the sample preparation system 301, a sample goes through a predefined and preprogrammed sequence depending on diagnosis or screening purposes in an automatic sample preparation unit 311. In embodiments, for glycan extraction, multiple processing modules may be selected, which as sample reception, protein denaturation, deglycosylation, protein removal, drying, centrifugation, solid phase extraction, and/or spotting. After sample preparation, the sample loader 312 loads the samples onto the plates 306 and are dried in a sample dryer 307.

The samples may then be provided to the MALDI-TOF MS unit 302 having an ion flight chamber 321 and/or a high voltage vacuum generator 322, in accordance with embodiments. A processing unit 323 in the MALDI-TOF MS may identify the time-of-flight of ionized particles and the corresponding intensity distribution detected by a detector. For the disease diagnostic purpose, in accordance with embodiments, those acquired time-of-flight and intensity data may be reorganized to set up a standard time-of-flight list, in which a concept of the center of time-of-flight distribution where intensities are balanced and equilibrated for each standard time-of-flight is introduced. A standard time-of-flight list may be based upon the machine accuracy and other relevant considerations. The stored spectrum data for each laser irradiation may also be used to set up the standard time-of-flight list. The diagnostic unit 303 may then compare, the spectra from a patient's sample with the pre-stored spectra and analyze the pattern difference of the two spectra. The diagnostic unit may then identify the presence and progress of the disease.

Example FIG. 4 is a system diagram of an integrated diagnostic system including a sample processing unit and a MALDI-TOF MS unit integrated in one system, whereas a diagnosis unit 403 is provided as a separate unit, in accordance with embodiments. Example FIG. 4 illustrates an integrated disease diagnosis system where the sample preparation unit 401 and the MALDI-TOF 402 are integrated, with the diagnosis unit 403 stands apart as a separate unit, in accordance with embodiments.

In embodiments, a diagnosis unit may utilize a reference library. A reference library may be co-located with a diagnosis unit or separated from a diagnosis unit. A diagnosis unit may be co-located with a spectrometer or separated from a spectrometer. In embodiments, the reference library may be stored in a storage device, a Matrix-Assisted Laser Desorption/Ionization Time-of-Flight Mass Spectrometer (MALDI-TOF MS), a data storage device in a spectrometer, a data storage device separate from a spectrometer, a data storage device in communication with a spectrometer through a network, a cloud storage system, and/or a data storage device in communication with a spectrometer through an internet connection.

Embodiments relate to an apparatus, method, or computer program. In embodiments, spectrometer test data of a sample may be received for processing (e.g. at diagnosis unit 103, 303, and/or 403). The spectrometer test data may be matched to a reference library to determine characteristic information of the sample. The reference library may include pre-stored spectrometer data in units of time and intensity of ionized particles. In embodiments, spectrometer test data is mass spectrometer test data and/or the spectrometer is a mass spectrometer. In embodiments, the spectrometer is a Matrix-Assisted Laser Desorption/Ionization Time-of-Flight Mass Spectrometer (MALDI-TOF MS).

In embodiments, the sample comprises biological molecules and/or the characteristic information of the sample includes biological analysis information of the sample. The biological analysis information may be a medical diagnosis of a human being, an animal, a plant, and/or a living organism.

For example, FIG. 5 shows spectra identifier 508 configured to communicate, via network 506, with mass spectrometer 502 and client devices 504a, 504b. Network 506 may correspond to a LAN, a wide area network (WAN), a corporate intranet, the public Internet, or any other type of network configured to provide a communications path between networked computing devices. The network 506 may also correspond to a combination of one or more LANs, WANs, corporate intranets, and/or the public Internet.

Although FIG. 5 only shows two client devices, distributed application architectures may serve tens, hundreds, or thousands of client devices. Moreover, client devices 504a and 504b (or any additional client devices) may be any sort of computing device, such as an ordinary laptop computer, desktop computer, network terminal, wireless communication device (e.g., a cell phone or smart phone), and so on. In some embodiments, client devices 504a and 504b can be dedicated to mass spectrometry and/or bacteriological research. In other embodiments, client devices 504a and 504b may be used as general purpose computers that are configured to perform a number of tasks and need not be dedicated to mass spectrometry or bacteriological research. In still other embodiments, the functionality of spectra identifier 508 and/or spectra database 510 can be incorporated in a client device, such as client devices 504a and/or 504b. In even other embodiments, the functionality of spectra identifier 508 and/or spectra database 510 can be incorporated into mass spectrometer 502.

Mass spectrometer 502 can be configured to receive an input material e.g., LA and/or LTA, and generate one or more spectra as output. For example, mass spectrometer 502 can be an electrospray ionization (ESI) tandem mass spectrometer or a SAWN-based mass spectrometer. In some embodiments, the output spectra can be provided to another device; e.g., spectra identifier 508 and/or spectra database 510, perhaps to be used as an input to the device. In other embodiments, the output spectra can be displayed on mass spectrometer 502, client devices 504a and/or 504b, and/or spectra identifier 508.

Spectra identifier 508 can be configured to receive, as an input, one or more spectra from mass spectrometer 502 and/or client device(s) 504a and/or 504b via network 506. In some embodiments, spectra identifier can be configured to directly receive input spectra via keystroke, touchpad or similar data input to spectra identifier 508, hard-wired connection(s) to mass spectrometer 502 and/or client device(s) 504a and/or 504b, accessing storage media configured to store input spectra (e.g., spectra database 510, flash media, compact disc, floppy disk, magnetic tape), and/or any other technique to directly provide input spectra to spectra identifier 508.

Spectra identifier 508 may be configured to generate results of spectra identification by comparing one or more input spectra to stored spectra 512. For example, stored spectra 512 can be known precursor ion mass spectrometry spectra. As shown in example FIG. 5, stored spectra 512 can reside in spectra database 510. When performing spectra identification, spectra identifier 508 can access and/or query spectra database 510 to retrieve part or all of stored spectra 512. In some embodiments, spectra identifier 508 can perform the comparison task directly; while in other embodiments, part or all of the spectra identification task can be performed by spectra database 510, perhaps by executing one or more query language commands upon stored spectra 512.

While FIG. 5 shows spectra identifier 508 and spectra database 510 directly connected, in other embodiments, spectra identifier 508 can include the functionality of spectra database 510, including storing stored spectra 512. In still other embodiments, spectra identifier 508 and spectra database 510 can be connected via network 506.

Upon identifying the input spectra, spectra identifier 508 can be configured to provide content at least related to results of spectra identification, as requested by client devices 504a and/or 504b. The content related to results of spectra identification can include, but is not limited to, web pages, hypertext, scripts, binary data such as compiled software, images, audio, and/or video. The content can include compressed and/or uncompressed content. The content can be encrypted and/or unencrypted. Other types of content are possible as well.

Example FIG. 6 is a block diagram of a computing device (e.g., system) in accordance with an example embodiment. In particular, computing device 600 shown in FIG. 6 can be configured to perform one or more functions of mass spectrometer 602, client device 604a, 604b, network 606, spectra identifier 608, spectra database 610, and/or stored spectra 512. Computing device 600 may include a user interface module 601, a network-communication interface module 602, one or more processors 603, and data storage 604, all of which may be linked together via a system bus, network, or other connection mechanism 605.

User interface module 601 can be operable to send data to and/or receive data from external user input/output devices. For example, user interface module 601 can be configured to send and/or receive data to and/or from user input devices such as a keyboard, a keypad, a touch screen, a computer mouse, a track ball, a joystick, a camera, a voice recognition module, and/or other similar devices. User interface module 601 can also be configured to provide output to user display devices, such as one or more cathode ray tubes (CRT), liquid crystal displays (LCD), light emitting diodes (LEDs), displays using digital light processing (DLP) technology, printers, light bulbs, and/or other similar devices, either now known or later developed. User interface module 601 can also be configured to generate audible output(s), such as a speaker, speaker jack, audio output port, audio output device, earphones, and/or other similar devices.

Network-communications interface module 602 can include one or more wireless interfaces 607 and/or one or more wireline interfaces 608 that are configurable to communicate via a network, such as network 506 shown in example FIG. 5. Wireless interfaces 607 can include one or more wireless transmitters, receivers, and/or transceivers, such as a Bluetooth transceiver, a Zigbee transceiver, a Wi-Fi transceiver, a WiMAX transceiver, and/or other similar type of wireless transceiver configurable to communicate via a wireless network. Wireline interfaces 608 may include one or more wireline transmitters, receivers, and/or transceivers, such as an Ethernet transceiver, a Universal Serial Bus (USB) transceiver, a Thunderbolt transceiver, or similar transceiver configurable to communicate via a twisted pair, one or more wires, a coaxial cable, a fiber-optic link, or a similar physical connection to a wireline network.

In embodiments, network communications interface module 602 may be configured to provide reliable, secured, and/or authenticated communications. For each communication described herein, information for ensuring reliable communications (i.e., guaranteed message delivery) can be provided, perhaps as part of a message header and/or footer (e.g., packet/message sequencing information, encapsulation header(s) and/or footer(s), size/time information, and transmission verification information such as CRC and/or parity check values). Communications can be made secure (e.g., be encoded or encrypted) and/or decrypted/decoded using one or more cryptographic protocols and/or algorithms, such as, but not limited to, DES, AES, RSA, Diffie-Hellman, and/or DSA. Other cryptographic protocols and/or algorithms can be used as well or in addition to those listed herein to secure (and then decrypt/decode) communications.

Processors 603 may include one or more general purpose processors and/or one or more special purpose processors (e.g., digital signal processors, application specific integrated circuits, etc.). Processors 603 can be configured to execute computer-readable program instructions 606 contained in storage 604 and/or other instructions as described herein.

Data storage 604 can include one or more computer-readable storage media that can be read and/or accessed by at least one of processors 603. The one or more computer-readable storage media can include volatile and/or non-volatile storage components, such as optical, magnetic, organic or other memory or disc storage, which can be integrated in whole or in part with at least one of processors 603. In some embodiments, data storage 604 can be implemented using a single physical device (e.g., one optical, magnetic, organic or other memory or disc storage unit), while in other embodiments, data storage 604 can be implemented using two or more physical devices.

Data storage 604 can include computer-readable program instructions 606 and perhaps additional data. For example, in embodiments, data storage 604 can store part or all of a spectra database and/or stored spectra, such as spectra database 510 and/or stored spectra 512, respectively. In some embodiments, data storage 604 can additionally include storage required to perform at least part of the herein-described methods and techniques and/or at least part of the functionality of the herein-described devices and networks.

In embodiments, data and services at spectra identifier 508 and spectra database 510 can be encoded as computer readable information stored in tangible computer readable media (or computer readable storage media) and accessible by client devices 504a and 504b, and/or other computing devices. In embodiments, data at spectra identifier 508 and/or spectra database 510 can be stored on a single disk drive or other tangible storage media, or can be implemented on multiple disk drives or other tangible storage media located at one or more diverse geographic locations.

Example FIG. 7 shows an example method 700 for spectral identification. At block 710, an input spectrum is received. The input spectrum can utilize any format for a spectrum, such as but not limited to utilizing a raw data format, JCAMP-DX, ANDI-MS, mzXML, mzData, and/or mzML. Other formats can be used as well or instead. At block 720, one or more peaks in the input spectrum are identified.

FIG. 8 shows and example input spectrum 860 and corresponding graph 862 of peaks of input spectrum 860. FIG. 8 specifically identifies the three highest peaks, respectively peaks 864a, 864b, and 864c, in input spectrum 860 as displayed in peak graph 862.

Returning to FIG. 7, at block 730, a comparison between peaks of the input spectra and peaks in one or more stored spectra is performed. The stored spectra can be stored in any format for a spectrum, such as but not limited to storage in a raw data format, JCAMP-DX, ANDI-MS, mzXML, mzData, and/or mzML. In embodiments, the input spectrum and/or some or all of the stored spectra can be converted between formats before or during the comparison. The stored spectra can also include additional information, such as a name of a compound, molecule, structure, substance, ion, fragment, or other identifier that can be used to identify the spectrum. For example, if a stored spectrum is a spectrum for pure water, then the stored spectrum can have additional information such as “water” or “H2O” to help identify the stored spectrum.

If the peaks of the input spectra match peaks in one or more stored spectra, method 700 proceeds to block 734. Otherwise, method 700 proceeds to block 732 where a “no match” display is generated and displayed. After completing the procedures of block 732, method 700 can proceed to block 750.

At block 734, the input spectrum is compared to each of the one or more matching and stored spectra identified at block 730. If the two spectra are not considered to match, method 700 can proceed to block 732 (transfer of control not shown in FIG. 7).

At block 740, when a match is found, an output based on the best matching spectrum can be generated. The output can indicate an identity of the matched spectrum. Also or instead, the input spectrum and/or the matched spectrum can be shown as part of the display.

The output may be provided using some or all components of a user interface module, such as user interface module 601, and/or a network communications interface module, such as network communication interface module 602. For example, the output can be displayed on a display, printed, emitted as sound using one or more speakers, and/or transmitted to another device using network communications interface module. Other examples are possible as well.

At block 750, a determination is made as to whether there are additional input spectra to be processed. If there are additional spectra to be processed, method 700 can proceed to block 710; otherwise, method 700 can proceed to block 752, where method 700 exits.

Example FIG. 9 depicts a block diagram of an exemplary system and network that may be utilized by and/or in the implementation of embodiments. Some or all of the exemplary architecture, including both depicted hardware and software, shown for and within computer 901 may be utilized by positioning system 951 and/or first mobile device 955 and/or second mobile device 957 shown in FIG. 9.

Exemplary computer 901 includes a processor 903 that is coupled to a system bus 905. Processor 903 may utilize one or more processors, each of which has one or more processor cores. A video adapter 907, which drives/supports a display 909, is also coupled to system bus 905. System bus 905 is coupled via a bus bridge 911 to an input/output (I/O) bus 913. An I/O interface 915 is coupled to I/O bus 913. I/O interface 915 affords communication with various I/O devices, including a keyboard 917, a mouse 919, a media tray 921 (which may include storage devices such as CD-ROM drives, multi-media interfaces, etc.), and external USB port(s) 925. While the format of the ports connected to I/O interface 915 may be any known to those skilled in the art of computer architecture, in one embodiment some or all of these ports are universal serial bus (USB) ports.

Also coupled to I/O interface 915 is a positioning system 951, which determines a position of computer 901 and/or other devices using positioning sensors 953. Positioning sensors 953, which may be any type of sensors that are able to determine a position of a computing device; e.g., computer 901, first mobile device 955, second mobile device 957, etc. Positioning sensors 953 may utilize, without limitation, satellite based positioning devices (e.g., global positioning system—GPS based devices), accelerometers (to measure change in movement), barometers (to measure changes in altitude), etc.

As depicted, computer 901 is able to communicate with first mobile device 955 and/or second mobile device 957 using a network interface 929. Network interface 929 is a hardware network interface, such as a network interface card (NIC), etc. Network 927 may be an external network such as the Internet, or an internal network such as an Ethernet or a virtual private network (VPN). In one or more embodiments, network 927 is a wireless network, such as a Wi-Fi network, a cellular network, etc.

A hard drive interface 931 is also coupled to system bus 905. Hard drive interface 931 interfaces with a hard drive 933. In one embodiment, hard drive 933 populates a system memory 935, which is also coupled to system bus 905. System memory is defined as a lowest level of volatile memory in computer 901. This volatile memory includes additional higher levels of volatile memory (not shown), including, but not limited to, cache memory, registers and buffers. Data that populates system memory 935 includes computer 901's operating system (OS) 937 and application programs 943.

Operating system (OS) 937 includes a shell 939, for providing transparent user access to resources such as application programs 943. Generally, shell 939 is a program that provides an interpreter and an interface between the user and the operating system. More specifically, shell 939 executes commands that are entered into a command line user interface or from a file. Thus, shell 939, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 141) for processing. While shell 139 is a text-based, line-oriented user interface, the present invention will equally well support other user interface modes, such as graphical, voice, gestural, etc.

As depicted, OS 937 also includes kernel 941, which includes lower levels of functionality for OS 937, including providing essential services required by other parts of OS 937 and application programs 943, including memory management, process and task management, disk management, and mouse and keyboard management.

Application programs 943 include a renderer, shown in exemplary mariner as a browser 945. Browser 945 includes program modules and instructions enabling a world wide web (WWW) client (i.e., computer 101) to send and receive network messages to the Internet using hypertext transfer protocol (HTTP) messaging, thus enabling communication with first mobile device 955, second mobile device 957, and/or other systems.

Application programs 943 in computer 901's system memory also include Logic for Managing Notifications to Mobile Devices (LMNMD) 947.

The hardware elements depicted in computer 901 are not intended to be exhaustive, but rather are representative to highlight essential components required by the present invention. For instance, computer 901 may include alternate memory storage devices such as magnetic cassettes, digital versatile disks (DVDs), Bernoulli cartridges, and the like. These and other variations are intended to be within the spirit and scope of the present invention.

Embodiments may be implemented in a cloud environment. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

A cloud consumer can unilaterally provision computing capabilities, such as server time and network storage, as needed automatically without requiring human interaction with the service's provider. Broad network access may allow for capabilities over a network and accessed through standard mechanisms that promote use by heterogeneous thin or thick client platforms (e.g., mobile phones, laptops, and PDAs). Resource pooling may allow for a provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity may allow for capabilities to be rapidly and elastically provisioned, in some cases automatically, to quickly scale out and rapidly released to quickly scale in. To the consumer, the capabilities available for provisioning often appear to be unlimited and can be purchased in any quantity at any time.

Measured service may allow cloud systems to automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Software as a Service (SaaS) may allow for capability provided to the consumer to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS) may include a capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS) may provide the capability to the consumer to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

A private cloud may be a cloud infrastructure is operated solely for an organization. It may be managed by the organization or a third party and may exist on-premises or off-premises. A community cloud may be a cloud infrastructure shared by several organizations and supports a specific community that has shared concerns (e.g., mission, security requirements, policy, and compliance considerations). It may be managed by the organizations or a third party and may exist on-premises or off-premises. A public cloud may be a cloud infrastructure made available to the general public or a large industry group and is owned by an organization selling cloud services. A hybrid cloud may be a cloud infrastructure that is composed of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 10, a schematic of an example of a cloud computing node is shown. Cloud computing node 1010 is only one example of a suitable cloud computing node and is not intended to suggest any limitation as to the scope of use or functionality of embodiments of the invention described herein. Regardless, cloud computing node 1010 is capable of being implemented and/or performing any of the functionality set forth hereinabove.

In cloud computing node 1010 there is a computer system/server 1012, which is operational with numerous other general purpose or special purpose computing system environments or configurations. Examples of well-known computing systems, environments, and/or configurations that may be suitable for use with computer system/server 1012 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1012 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1012 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 10, computer system/server 1012 in cloud computing node 1010 is shown in the form of a general-purpose computing device. The components of computer system/server 1012 may include, but are not limited to, one or more processors or processing units 1016, a system memory 1028, and a bus 1018 that couples various system components including system memory 1028 to processor 1016.

Bus 1018 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1012 typically includes a variety of computer system readable media. Such media may be any available media that is accessible by computer system/server 1012, and it includes both volatile and non-volatile media, removable and non-removable media. System memory 1028 can include computer system readable media in the form of volatile memory, such as random access memory (RAM) 1030 and/or cache memory 1032. Computer system/server 1012 may further include other removable/non-removable, volatile/non-volatile computer system storage media. By way of example only, storage system 1034 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1018 by one or more data media interfaces. As will be further depicted and described below, memory 1028 may include at least one program product having a set (e.g., at least one) of program modules that are configured to carry out the functions of embodiments of the invention.

Program/utility 1040, having a set (at least one) of program modules 1042, may be stored in memory 1028 by way of example, and not limitation, as well as an operating system, one or more application programs, other program modules, and program data. Each of the operating system, one or more application programs, other program modules, and program data or some combination thereof, may include an implementation of a networking environment. Program modules 1042 generally carry out the functions and/or methodologies of embodiments of the invention as described herein.

Computer system/server 1012 may also communicate with one or more external devices 14 such as a keyboard, a pointing device, a display 1024, etc.; one or more devices that enable a user to interact with computer system/server 1012; and/or any devices (e.g., network card, modem, etc.) that enable computer system/server 1012 to communicate with one or more other computing devices. Such communication can occur via Input/output (I/O) interfaces 1022. Still yet, computer system/server 1012 can communicate with one or more networks such as a local area network (LAN), a general wide area network (WAN), and/or a public network (e.g., the Internet) via network adapter 1020. As depicted, network adapter 1020 communicates with the other components of computer system/server 1012 via bus 1018. It should be understood that although not shown, other hardware and/or software components could be used in conjunction with computer system/server 1012. Examples, include, but are not limited to: microcode, device drivers, redundant processing units, external disk drive arrays, RAID systems, tape drives, and data archival storage systems, etc.

Referring now to FIG. 11, illustrative cloud computing environment 1150 is depicted. As shown, cloud computing environment 1150 comprises one or more cloud computing nodes 1110 with which local computing devices used by cloud consumers, such as, for example, personal digital assistant (PDA) or cellular telephone MA, desktop computer MB, laptop computer MC, and/or automobile computer system MN may communicate. Nodes 1110 may communicate with one another. They may be grouped (not shown) physically or virtually, in one or more networks, such as Private, Community, Public, or Hybrid clouds as described hereinabove, or a combination thereof. This allows cloud computing environment 1150 to offer infrastructure, platforms and/or software as services for which a cloud consumer does not need to maintain resources on a local computing device. It is understood that the types of computing devices MA-N shown in FIG. 11 are intended to be illustrative only and that computing nodes 1110 and cloud computing environment 1150 can communicate with any type of computerized device over any type of network and/or network addressable connection (e.g., using a web browser).

Referring now FIG. 12, a set of functional abstraction layers provided by cloud computing environment 1150 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 1260 includes hardware and software components. Examples of hardware components include: mainframes 1261; RISC (Reduced Instruction Set Computer) architecture based servers 1262; servers 1263; blade servers 1264; storage devices 1265; and networks and networking components 1266. In some embodiments, software components include network application server software 1267 and database software 1268.

Virtualization layer 1270 provides an abstraction layer from which the following examples of virtual entities may be provided: virtual servers 1271; virtual storage 1272; virtual networks 1273, including virtual private networks; virtual applications and operating systems 1274; and virtual clients 1275.

In one example, management layer 1280 may provide the functions described below. Resource provisioning 1281 provides dynamic procurement of computing resources and other resources that are utilized to perform tasks within the cloud computing environment. Metering and Pricing 1282 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1283 provides access to the cloud computing environment for consumers and system administrators. Service level management 1284 provides cloud computing resource allocation and management such that required service levels are met. Service Level Agreement (SLA) planning and fulfillments 1285 provide pre-arrangement for, and procurement of, cloud computing resources for which a future requirement is anticipated in accordance with an SLA.

Workloads layer 1290 provides examples of functionality for which the cloud computing environment may be utilized. Examples of workloads and functions which may be provided from this layer include: mapping and navigation 1291; software development and lifecycle management 1292; virtual classroom education delivery 1293; data analytics processing 94; transaction processing 1295; and matching processing 1296 for spectrometer data.

Embodiments relate to an apparatus, method, or computer program. Spectrometer test data of a sample may be received. The received test data may be matched to a reference library to determine characteristic information of the sample by correlating the test data to at least one of a plurality of reference data in the reference library. The updating the reference library with the test data as new reference data based is on the correlating. In embodiments, the matching is performed in a cloud computing system.

In embodiments, a cloud computing system includes a plurality of processors coupled together through networks to perform at least one of data processing or data storage operation. In embodiments, the reference library is stored in at least one data center coupled to the spectrometer through the cloud computing system. In embodiments, the test data is received from a spectrometer coupled to the cloud computing system. In embodiments, the spectrometer test data is mass spectrometer test data. In embodiments, the spectrometer test data comprises information from a Matrix-Assisted Laser Desorption/Ionization Time-of-Flight Mass Spectrometer (MALDI-TOF MS).

In embodiments, the test data is at least one of manipulated and/or processed prior to the matching. In embodiments, the reference data has known characteristics that the matching associates with the received test data. In embodiments, the test data and the reference data correspond to peaks in mass spectrum of ionized particles in a spectrometer.

In embodiments, a collection of distribution curves is coupled into one function from the distribution curve for each mass spectrum. In embodiments, cross correlation between two function may be modified. In embodiments, a similarity coefficient between the two functions may be determined. In embodiments, if the two functions between the test data and the library database substantially overlap, then determining that the test data and at least one of a plurality of reference data in the reference library have a match.

Embodiments relate to identifying at least one biomarker from the test data. In embodiments, the sample include biological molecules. Characteristic information of the sample may include a biological analysis information of the sample. The biological analysis information may be a medical diagnosis of at least one of a human being, an animal, a plant, or a living organism.

In embodiments, a matching operation may be optimized by a computer algorithm. The computer algorithm may cause the library database to evolve through dynamic analytics. The dynamic analytics may include artificial intelligence or a deep learning algorithm.

In embodiments, the received test data comprises metadata information relating to a source of the sample. The metadata information may be stripped of personal information relating to the source of the sample.

In embodiments, ionized particles are generated by a laser configured to irradiate a target area to ionize the sample placed in the target area. A first end of a flight tube may be proximate to at least one electrode configured to accelerate the ionized particles into the flight tube. A second opposite end of the flight tube may be proximate to a detector which measures the ionized particles through the flight tube and an intensity of the ionized particles.

In embodiments, the attributes of each of the ionized particles comprises at least one of: An acceleration efficiency of each of the ionized particles through at least one electrode. Delays in at least one of the ionized particles entering the flight tube. Variations of path of flight of at least one of the ionized particles inside the flight tube.

In embodiments, the matching includes at least one of: Compensating for physical variations in the sample. Optimizing data reproducibility. Maximizes diagnostic accuracy.

In embodiments, a reference library is stored in at least one of a storage device, a Matrix-Assisted Laser Desorption/Ionization Time-of-Flight Mass Spectrometer (MALDI-TOF MS), a local data storage device, a remote data storage device outside the apparatus performing the method, a data storage device in communication through a network, a cloud storage system, or a data storage device in communication through an internet connection.

Recent commercialization of mass spectrometers with fast analysis speeds and high sensitivity has expanded the prospects of their applications from high technology research to medical diagnosis. Mass spectrometry has the potential to replace existing medical diagnosis techniques. However, different diseases or disease statuses may display identical or similar symptoms and changes to the body, its cells, or cellular substance. Therefore, until data is corroborated with information collected from other diseases rather than just the original target disease, mere presence of a particular disease's biomarker information should not be regarded as an authentic identifier that effectively pinpoints the disease or its source.

Mass Spectrometry, especially MALDI-TOF MS based diagnostics may have a great potential to resolve those problems occurring from insufficient information about other diseases or statuses of diseases. The system can use the concept of database based library diagnostics, where all the information about other diseases or statuses are pre-built as a reference database.

In some circumstances, after mass data is calibrated and adjusted, it is then matched one by one with the mass data of samples of known identities in a reference database. If the data matches, the test sample's identity is determined to be the identity of the sample to which it was compared. A target diagnosis method may employ a personal empirical guess and test-method until the correct match is found. However, the library diagnostics is using a pre-built database based on a variety of data and validation though optimized computer algorithms, which may yield better diagnostics.

Embodiments relate to library diagnostics based upon a pre-built reference database for diseases and/or statuses of diseases diagnostics and/or microorganisms identification may be implemented. Databases of proteins, peptides, lipids, and/or other targets for microorganisms, diseases, and/or statuses of diseases may be pre-defined as reference, in accordance with embodiments.

Embodiments relate to use of a library database in a MALDI-TOF system. Diagnostic techniques may be limited because they involve target diagnostics in which a test sample is being compared to only one or a few diseases or status at a time. Target diagnostics may be limited in that it may be prone false positive or false negative errors and/or may be inefficient. Embodiments relate to a designation by a tester (e.g. human ordering the test) to have a general idea of what to test for, otherwise the diagnosis may be overly time consuming and/or inconclusive. In embodiments, a library database may be superior to target diagnostics, because a test sample may be compared to many different diseases and statuses simultaneously, thus reducing the risk of false positive or false negative errors and/or increasing efficiency. In embodiments, a database may be built up with more and more data, yielding better and better analysis as time goes on as more data is acquired.

Embodiments identify a sample by analyzing the noticeable peaks in the sample's mass spectrum. If a peak in a mass spectrum shows that the intensity of a mass exceeds a certain threshold, the peak may be considered to be meaningful in the sample's identification. Otherwise, the peak or peaks may be considered to be mere noise or otherwise irrelevant information. Meaningful peaks in mass spectrometry may be used to identify an unknown sample.

Methods for sample identification and matching may focus on identifying these meaningful peaks as well. Typically, meaningful peaks from the mass spectrum of an unknown sample may be selected based on set thresholds. Then, the meaningful or supposed-to-be meaningful peak or a peaks may be compared with the one or multiples of a target disease, species, or strain. This technique and similar techniques may be referred to as target diagnostics or target ID. This ID is a sequential process, which repeats its work until the desired solution is found, and not a one-time diagnostic process as library database diagnostics.

Target ID/diagnostics techniques may be susceptible to false negative errors which occur when the diagnosis incorrectly identifies a test sample as normal or healthy when in actuality the sample is diseased, etc. Target ID's may not guarantee the absolute normality or healthiness of a test sample, because while the test sample may be negative for the single disease/strain it is tested against, the sample may nonetheless contain a disease or strain different from the one it was tested against. Embodiments may include comparison of test sample data against data of not just one disease or strain but rather a library database of diseases, disease statuses, and strains. Embodiment may mitigate the inherent false negative tendency of target diagnostics. Embodiments may present a method for detecting a change, imbalance, and/or status shift of a disease. Some embodiments may estimate the extent of the change or imbalance from any specified status of a disease and may optimize reliability of diagnosis. Embodiments may require a more intensive sorting, clustering or categorizing, and matching algorithm than mere disease detection.

Embodiments relate to cross correlation with the mass distribution curves obtained from MALDI-TOF MS experimentation on samples to find a similarity between two functions as a function of lag. The same computing process may be applied when making profiles and functions for both the reference database as well as the test sample data, in accordance with embodiments.

(f*g)(τ) [symbol] ∫_{-∞}^{∞}f*(t) g(t+τ) dt, for continuous function

$$( f * g ) [ n ] {\sum }_{m = - ∞}^{∞} f * [ m ] g [ m + n ] .$$

for discrete function

Embodiments relate to compiling the collection of distribution curves into one function from the distribution curve for each mass gathered from mass spectrometry. By computing a norm (distance) of the difference or overlapping area between the functions, embodiments modify the cross correlation between two functions and can determine a similarity coefficient between two functions. If the functions between the sample data and the database data highly overlap, this may indicate that the selected samples have a high likelihood of matching, in accordance with embodiments.

There may often be shifts in mass spectrums due to factors such as errors in sample preparation or the mass spectrometer itself. These shifts may require the implementation of a calibration process to account for these inconsistencies. The cross correlation method in accordance with embodiments with its greater accuracy may replace less accurate calibration techniques.

Cross correlation may also be used in signal processing as well as photogrammetry to match signals and/or images together. In embodiments, cross correlation applications to mass spectrometry may be advantageous, because the range of mass to charge ratios may be finite. The fact that all intensity outputs are positive may eliminate otherwise necessary normalization processes, in accordance with embodiments. Due to these advantages, finding cross correlation between samples may be quickly done with the correct algorithms, in accordance with embodiments. Furthermore, the limited range of mass spectrum outputs in embodiments may allow the range of cross correlation functions/index to be controlled. This may yield an additional constraint, which in turn may simplify and expedite the algorithms used to find the cross correlation coefficients, in accordance with embodiments.

Any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

It will be obvious and apparent to those skilled in the art that various modifications and variations can be made in the embodiments disclosed. This, it is intended that the disclosed embodiments cover the obvious and apparent modifications and variations, provided that they are within the scope of the appended claims and their equivalents.

What is claimed is:

1. A method comprising:
receiving spectrometer test data of a sample;
matching the spectrometer test data to a reference library to determine characteristic information of the sample by correlating the spectrometer test data to at least one of a plurality of reference data in the reference library; and
updating the reference library with the spectrometer test data as new reference data based on the correlating.

2. The method of claim 1, wherein the method is performed in a cloud computing system.

3. The method of claim 2, wherein the cloud computing system comprises a plurality of processors coupled together through networks to perform at least one of data processing or data storage operation.

4. The method of claim 2, wherein the reference library is stored in at least one data center coupled to the spectrometer through the cloud computing system.

5. The method of claim 2, wherein the test data is received from a spectrometer coupled to the cloud computing system.

6. A method of claim 1, wherein the spectrometer test data is mass spectrometer test data.

7. The method of claim 6, wherein the spectrometer test data comprises information from a Matrix-Assisted Laser Desorption/Ionization Time-of-Flight Mass Spectrometer (MALDI-TOF MS).

8. The method of claim 1, wherein the spectrometer test data is at least one of manipulated and/or processed prior to the matching.

9. The method of claim 1, wherein the reference data has known characteristics that the matching associates with the received spectrometer test data.

10. The method of claim 1, wherein the test data and the reference data correspond to peaks in mass spectrum of ionized particles in a spectrometer.

11. The method of claim 10, comprising:
compiling a collection of distribution curves into one function from the distribution curve for each mass spectrum;
modifying cross correlation between two functions;
determining a similarity coefficient between the two functions; and
if the two functions between the test data and the library database substantially overlap, then determining that the test data and at least one of a plurality of reference data in the reference library have a match.

12. The method of claim 1, comprising identifying at least one biomarker from the spectrometer test data.

13. The method of claim 1, wherein:
the sample comprises molecules;
characteristic information of the sample comprises a biological analysis information of the sample.

14. The method of claim 13, wherein the biological analysis information is a medical diagnosis of at least one of a human being, an animal, a plant, or a living organism.

15. The method of claim 1, wherein the matching is optimized by a computer algorithm.

16. The method of claim 15, wherein the computer algorithm causes the library database to evolve through dynamic analytics.

17. The method of claim 16, wherein the dynamic analytic comprises at least one of artificial intelligence or a deep learning algorithm.

18. The method of claim 1, wherein the received test data comprises metadata information relating to a source of the sample.

19. The method of claim 18, wherein the metadata information is stripped of personal information relating to the source of the sample.

20. The method of claim 1, wherein:
ionized particles are generated by a laser configured to irradiate a target area to ionize the sample placed in the target area;
a first end of a flight tube is proximate to at least one electrode configured to accelerate the ionized particles into the flight tube; and
a second opposite end of the flight tube is proximate to a detector which measures the ionized particles through the flight tube and an intensity of the ionized particles.

21. The method of claim 20, wherein the attributes of each of the ionized particles comprises at least one of:
an acceleration efficiency of each of the ionized particles through at least one electrode;
delays in at least one of the ionized particles entering the flight tube; or
variations of path of flight of at least one of the ionized particles inside the flight tube.

22. The method of claim 1, wherein the matching at least one of:
compensates for physical variations in the sample;
optimizes data reproducibility; or
maximizes diagnostic accuracy.

23. The method of claim 1, wherein the reference library is stored in at least one of a storage device, a Matrix-Assisted Laser Desorption/Ionization Time-of-Flight Mass Spectrometer (MALDI-TOF MS), a data storage device in an apparatus performing the method, a data storage device outside the apparatus performing the method, a data storage device in communication with the apparatus performing the method, through a network, a cloud storage system, or a data storage device in communication with the apparatus performing the method through an internet connection.

24. An apparatus comprising:
at least one processor;
a receiving unit configured to receive spectrometer test data of a sample
a matching unit configured to match the spectrometer test data to a reference library to determine characteristic information of the sample by correlating the spectrometer test data to at least one of a plurality of reference data in the reference library; and
an updating unit configured to update the reference library with the test data as new reference data by on the correlating.

25. A computer program product, comprising a computer readable hardware storage device having computer readable program code stored therein, said program code containing instructions executable by one or more processors of a computer system to implement a method of assessing damage to an object, said method comprising:
receiving spectrometer test data of a sample;
matching the spectrometer test data to a reference library to determine characteristic information of the sample by correlating the spectrometer test data to at least one of a plurality of reference data in the reference library; and
updating the reference library with the spectrometer test data as new reference data based on the correlating.
